(19) United States
(12) Patent Application Publication
(10) Pub. No.: US 2026/0316707 A1
(43) Pub. Date: Oct. 15, 2026

(54) VEHICULAR RADAR SENSING SYSTEM FOR IN-CABIN MONITORING WITH OBJECT IDENTIFICATION AND LOCALIZATION

(71) Applicant: Magna Electronics Inc., Auburn Hills, MI (US)

(72) Inventor: Tojo Tom, Kerala (IN)

(21) Appl. No.: 19/642,874

(22) Filed: Apr. 9, 2026

Related U.S. Application Data
(60) Provisional application No. 63/786,381, filed on Apr. 10, 2025.

(51) Int. Cl. B60R 21/015; G01S 7/35; G01S 7/41; G01S 13/32

(52) U.S. Cl. CPC B60R 21/01534; G01S 7/352; G01S 7/417; G01S 13/32

(57) ABSTRACT

A method includes capturing, by a radar sensor, radar sensor data within an interior cabin of a vehicle. The method includes spatially resolving the radar sensor data to isolate signals corresponding to a plurality of occupant positions within the interior cabin and generating a respective two-dimensional radar feature map for each occupant position.

The method includes generating a multi-dimensional data tensor combining the respective two-dimensional radar feature maps that include a spatial dimension corresponding to the plurality of occupant positions. The method includes providing the multi-dimensional data tensor as an input to a neural network executed by the processor, wherein the spatial dimension corresponding to the plurality of occupant positions is processed as an input channel dimension of the neural network. The method includes determining, based on an output of the neural network, a classification associated with occupancy for each occupant position of the plurality of occupant positions.

### CROSS REFERENCE TO RELATED APPLICATION

The present application claims the filing benefits of U.S. provisional application Ser. No. 63/786,381, filed Apr. 10, 2025, which is hereby incorporated herein by reference in its entirety.

### TECHNICAL FIELD

The present invention relates generally to a vehicular cabin monitoring system for a vehicle and, more particularly, to a vehicular cabin monitoring system that utilizes one or more radar sensors at a vehicle.

### BACKGROUND

Use of radar sensors in vehicle sensing systems is common and known.

Examples of such known systems are described in U.S. Pat. Nos. 9,146,898; 8,027,029 and/or 8,013,780, which are hereby incorporated herein by reference in their entireties.

### SUMMARY

A vehicular cabin monitoring system includes a radar sensor disposed within an interior cabin of a vehicle. The radar sensor captures radar sensor data within the interior cabin. The system includes an electronic control unit (ECU) with a processor and memory. The ECU receives the captured radar sensor data and is configured to spatially resolve the radar sensor data to isolate signals corresponding to a plurality of occupant positions within the interior cabin. The ECU is also configured to generate a respective two-dimensional radar feature map for each occupant position of the plurality of occupant positions based on the spatially resolved radar sensor data. The ECU is configured to generate a multi-dimensional data tensor combining the respective two-dimensional radar feature maps. The multi-dimensional data tensor includes a spatial dimension corresponding to the plurality of occupant positions. The ECU is configured to provide the multi-dimensional data tensor as an input to a neural network executed by the processor. The spatial dimension corresponding to the plurality of occupant positions is processed as an input channel dimension of the neural network. The ECU is configured to determine, based on an output of the neural network, a classification associated with occupancy for each occupant position of the plurality of occupant positions.

These and other objects, advantages, purposes and features of the present invention will become apparent upon review of the following specification in conjunction with the drawings.

### BRIEF DESCRIPTION OF THE DRAWINGS

FIG. 1 is a top view of a vehicle with a sensing system that incorporates a radar sensor;

FIG. 2 is flowchart for the sensing system of FIG. 1;

FIG. 3 is a block diagram for the sensing system of FIG. 1;

FIG. 4 is a schematic view of beam steering and network architecture;

FIG. 5 is a table of an exemplary architecture of a convolutional neural network;

FIG. 6 is a confusion matrix for single occupant scenarios; and

FIG. 7 is a table for precision, recall, and F1-score for multi-occupant scenarios.

### DETAILED DESCRIPTION

Automotive safety technology is continually evolving, particularly with the advent of connected and automated vehicles. A significant area of development involves monitoring the interior cabin of a vehicle to detect the presence, location, and characteristics of occupants. Such in-cabin occupant detection systems can enhance the effectiveness of passive safety systems, such as by enabling adaptive airbag deployment strategies or refining seat belt reminder logic based on the detected occupant type (e.g., adult vs. child). Furthermore, these systems play an important role in preventing incidents such as children being inadvertently left unattended in vehicles, which can lead to heatstroke. Child Presence Detection (CPD) is increasingly becoming a focus area, potentially driven by regulatory considerations (e.g., Euro NCAP (new car assessment program), U.S. regulations).

Traditional approaches to occupant detection have included pressure sensors integrated into seats or camera-based monitoring systems. However, pressure sensors may have limitations in accurately classifying occupants or detecting presence in all situations. Camera-based systems, while capable of providing rich visual information, can raise privacy concerns among occupants and may suffer performance degradation under variable lighting conditions (e.g., low light, glare) or if the camera's view is obstructed.

Frequency-modulated continuous-wave (FMCW) radar technology presents a promising alternative for in-cabin sensing. Radar sensors operate effectively across various lighting and weather conditions. As radar does not capture detailed visual images like a camera, it inherently offers better preservation of occupant privacy. FMCW radar systems can provide multi-dimensional information about detected targets, including their range (distance), relative velocity (Doppler), and angular position (azimuth and elevation). This rich dataset can be leveraged for precise occupant detection, localization, and classification.

While radar-based systems offer advantages, challenges remain, particularly for deployment in resource-constrained automotive environments. Some existing radar-based solutions may utilize complex multi-channel radar systems or employ computationally intensive signal processing and machine learning algorithms (e.g., deep neural networks) that are not suitable for implementation on typical automotive-grade microcontrollers (MCUs) or electronic control units (ECUs). These platforms often have strict limitations on available processing power (compute capacity, often measured in operations like multiply-accumulate or MACs), memory (RAM for execution and ROM/Flash for storage), and power consumption, while also requiring real-time performance (low latency).

Therefore, there is a need for an in-cabin occupant detection system that leverages the benefits of FMCW radar while employing efficient signal processing and optimized machine learning models capable of running effectively on resource-constrained embedded hardware, accurately distinguishing between different types of occupants (e.g., adults, children/babies) and non-living objects under diverse in-cabin conditions. Challenges include extracting reliable features from potentially noisy or low-resolution radar data, designing deep learning architectures with low memory footprints (e.g., below approximately 100 KB or 50 KB after quantization) and low computational complexity (e.g., around 2 million or 1 million MAC operations or less) resulting in low inference latency (e.g., approximately 5 ms or 2.5 ms or less), and achieving robust classification performance.

A vehicle sensing system and/or cabin monitoring system and/or occupant monitoring system operates to capture sensing data interior of the vehicle and may process the captured data to detect objects within the vehicle, such as to monitor a status of one or more occupants of the vehicle. The system includes a processor that is operable to receive sensing data from one or more sensors and provide an output, such as an alert or control of a vehicle system.

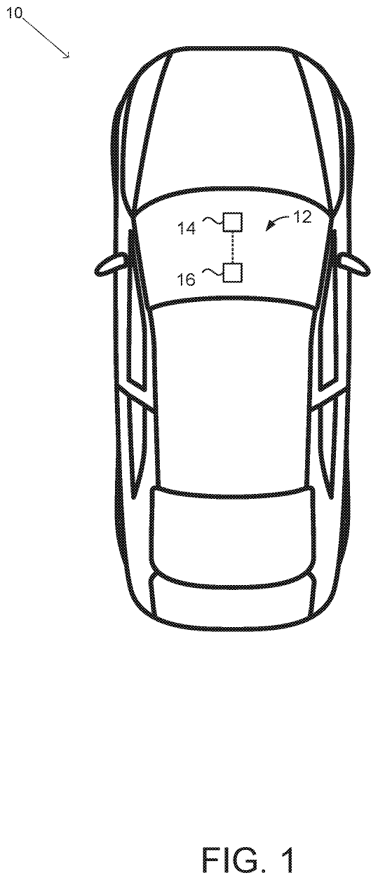

Referring now to the drawings and the illustrative embodiments depicted therein, a vehicle 10 (FIG. 1) includes an occupant monitoring system or sensing system 12 that includes at least one radar sensor unit, such as an interior radar sensor unit 14 (and the system may optionally include multiple sensors, such as cameras, radar, or other sensors), which senses regions interior of the vehicle. The radar sensor 14 may be disposed at any location within the cabin of the vehicle, such as at a dash/dashboard or console of the vehicle. The sensing system 12 includes a control or electronic control unit (ECU) 16 that includes a data processor that is operable to process data captured by the radar sensor(s). The radar sensor may include a plurality of transmitters that transmit radio signals via plurality of antennas. The radar sensor may also include a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driver monitoring system or an occupant monitoring system of the vehicle, with the system detecting and/or monitoring at least one occupant of the vehicle (such as to monitor a health or status of the occupant) responsive to processing of the data captured by the radar sensors. The data transfer or signal communication from the sensor to the ECU may comprise any suitable data or communication link, such as a vehicle network bus or the like of the equipped vehicle.

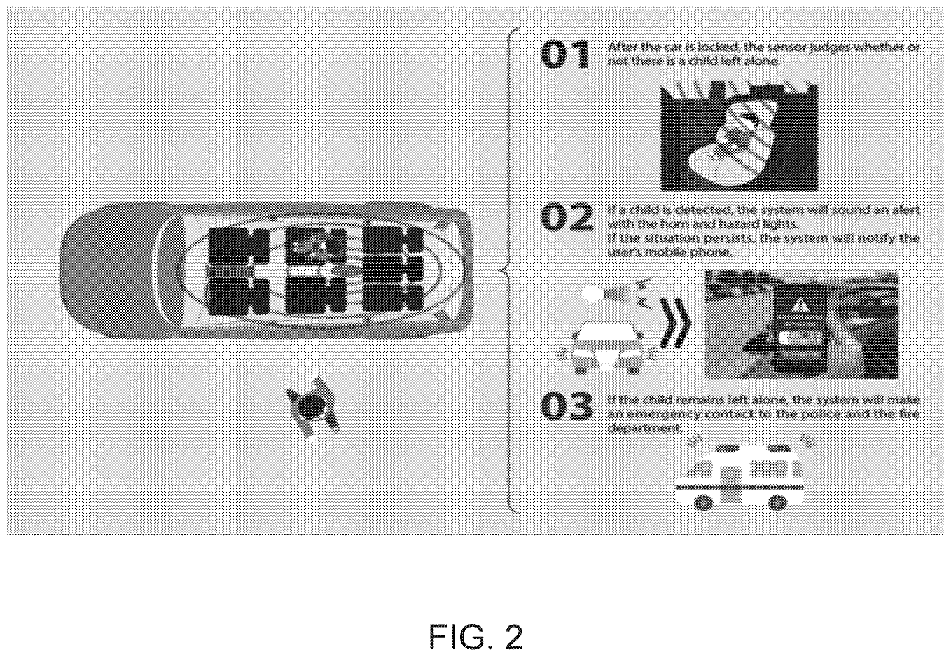

Referring now to FIG. 2, the radar sensor is disposed within the interior cabin of a vehicle equipped with the system. The radar sensor is configured to sense the environment within the interior cabin. The radar sensor may be an FMCW (Frequency-Modulated Continuous-Wave) radar sensor. FMCW radar operates by transmitting a signal whose frequency increases linearly over time (i.e., a “chirp”). By mixing the transmitted signal with the received echo signal reflected from targets, a beat signal is generated. The frequency of this beat signal is proportional to the range (i.e., distance) of the target. By analyzing the phase change across multiple chirps, the relative velocity (i.e., Doppler shift) of the target can also be determined. Furthermore, by using multiple receive antennas, the angle of arrival (i.e., azimuth and elevation) of the signal can be estimated, allowing for spatial localization of targets. The radar sensor is strategically positioned within the cabin (e.g., overhead console, dashboard, etc.) to provide adequate coverage of the desired passenger regions, such as all seating positions.

The ECU is communicatively coupled to the radar sensor to receive sensor data. The ECU comprises electronic circuitry, including at least one processor (e.g., a microprocessor, microcontroller, digital signal processor (DSP), or application-specific integrated circuit (ASIC)) and associated memory (e.g., RAM, ROM, Flash memory). The memory stores instructions (e.g., software, firmware) that, when executed by the processor, cause the ECU to perform the processing steps described herein. In some implementations, the target hardware platform for the ECU may be an automotive-grade microcontroller, such as an Infineon MCU, potentially having specific resource constraints, for example, around 1.5 MB of RAM and 2 MB of ROM. The processing described may occur entirely on the ECU associated with the radar or potentially distributed between the radar sensor's integrated processing unit and a central vehicle ECU. The radar sensor captures raw sensor data representing the echoes received from the cabin interior. This raw data is transferred to the ECU for processing.

The process includes generating a structured data representation suitable for input into a machine learning model. This may involve leveraging knowledge of the vehicle's interior geometry, specifically the predefined locations of occupant positions (e.g., seats). Alternatively or additionally, this involves dynamically finding potential seat locations using beam-steering techniques. That is, using the received radar signals, potentially from multiple receiver channels, the system may apply digital beamforming or beam-steering techniques. Beamforming electronically focuses the sensitivity of the radar receiver array towards specific directions. Optionally, beamforming may be used to steer the receive beams towards each of the known, predefined seat locations (e.g., driver seat, front passenger seat, rear left, rear center, rear right).

For each targeted seat location, the beamformed radar data is processed to extract relevant features. A common representation is a Range-Doppler (RD) map (i.e., a heatmap). An RD map is typically a two-dimensional matrix where one dimension represents range bins (i.e., discretized distances) and the other represents Doppler bins (i.e., discretized velocities). The value in each cell of the RD map indicates the signal strength or energy reflected from a target at that specific range and velocity within the steered beam corresponding to that seat. Notably, the Doppler information within these RD maps can capture not only bulk motion but also subtle movements, which may include micro-Doppler signatures associated with physiological signals like respiration or heart rate, further enriching the data used for classification. This process results in a separate RD map for each of the N monitored seat locations.

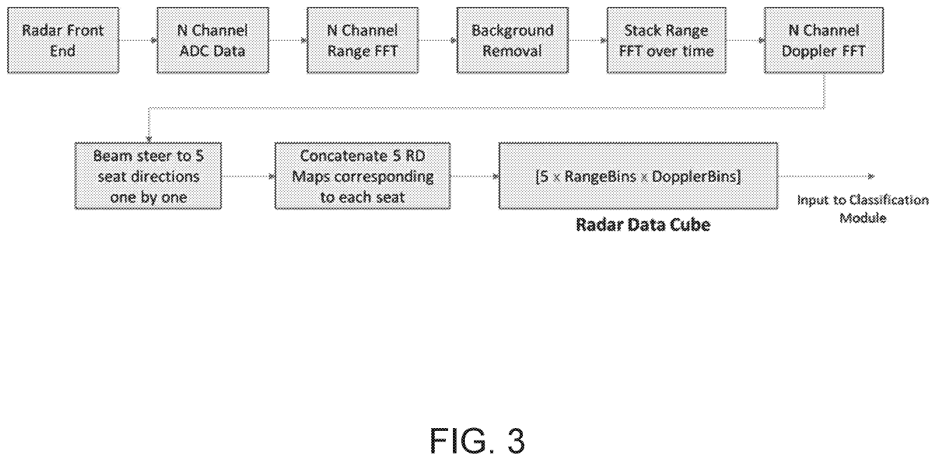

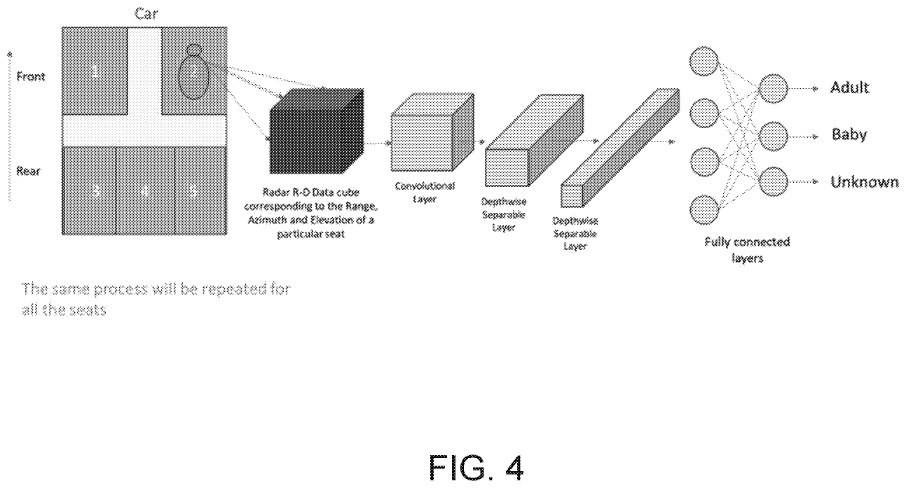

These individual RD maps may be combined or organized into a multi-dimensional data structure. If each RD map has dimensions R (range bins) x D (Doppler bins), combining the maps for N seats results in a data structure with dimensions N×R×D. This tensor serves as the input to the classification model (FIG. 3). This structure incorporates spatial information (via the N dimension corresponding to different seat locations/beam directions) along with range and velocity information for each location. This can be considered a three-dimensional (3D) data structure capturing the state of the monitored occupant positions. The generation of this structure effectively uses a first portion of sensor data (processed via beamforming for a first seat) representative of a first viewing angle/direction and a second portion of sensor data (processed via beamforming for a second seat) representative of a second viewing angle/direction, and so on for all N seats, to build the comprehensive N×R×D representation (FIG. 4).

Prior to generating the RD maps or feeding the data structure to the classification model, various pre-processing steps may be applied to the raw or intermediate radar data. These steps aim to improve signal quality and prepare the data for the model. Examples include noise reduction techniques (e.g., filtering, applying windowing functions like Hanning or Hamming windows before Fourier transforms), signal normalization (e.g., scaling data values to a specific range, such as [0, 1] or [−1, 1]), and potentially background subtraction or clutter removal to eliminate static reflections. The pre-processed data is then structured into the final N×R×D tensor format.

The vehicular cabin monitoring system uses the generated multi-dimensional data structure (e.g., the N×R×D tensor) as input to a computational model, executed on the ECU, to determine a classification for each occupant position. Optionally, this model is a convolutional neural network (CNN).

The CNN is specifically designed and optimized for efficiency to meet the stringent computational and memory constraints of embedded automotive hardware. An architectural feature that may contribute to this efficiency is the use of depthwise separable convolutions instead of, or in addition to, standard convolutional layers. A depthwise separable convolution consists of two stages: depthwise convolution and pointwise convolution. Depthwise convolution refers to performing spatial convolution independently for each input channel. If the input has M channels, the depthwise convolution applies M separate filters, one for each channel. Pointwise convolution refers to applying 1×1 convolutions across the channels to combine the outputs from the depthwise stage. This effectively mixes information across channels. This factorization significantly reduces the number of parameters and the computational cost (i.e., MAC operations) compared to a standard convolution performing spatial filtering and channel mixing simultaneously.

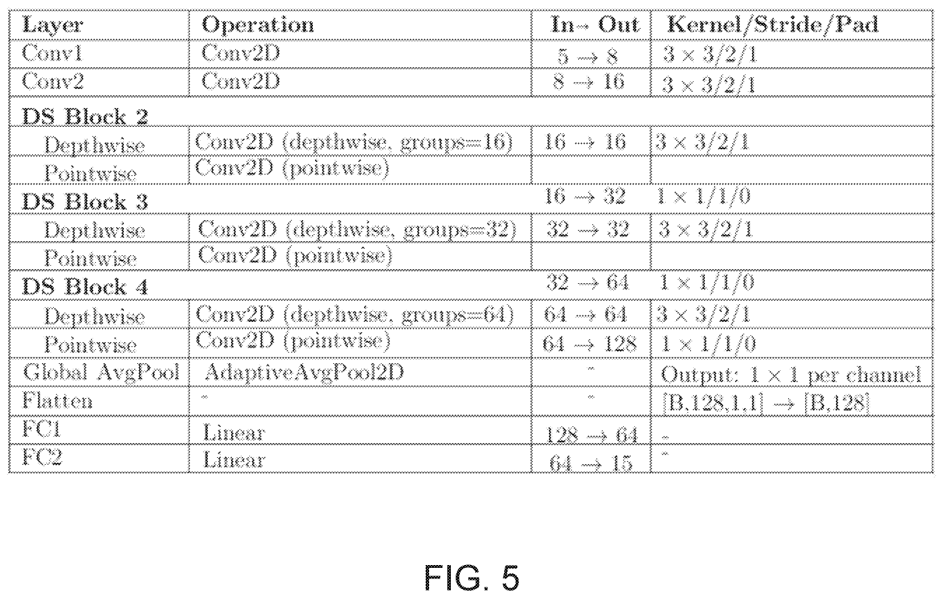

As shown in FIG. 5, the CNN is specifically configured to ingest the multi-dimensional data structure. In an exemplary embodiment, the CNN treats the N dimension (representing the different seat locations or beamformed viewing angles) as the input channel dimension for a two-dimensional spatial convolution. For example, if the system monitors five seats (N=5), the input to the CNN is a 2D tensor with 5 input channels, where the spatial dimensions correspond to the Range and Doppler bins. This configuration allows the CNN to simultaneously extract features across all monitored seating positions while minimizing computational overhead.

An example CNN architecture suitable for this application comprises a highly optimized progression of standard and depthwise separable convolutional layers designed to maintain a parameter memory footprint below 50 KB. In one embodiment, the CNN includes a first standard two-dimensional convolutional layer (Conv1) that receives the input tensor (e.g., 5 channels) and outputs 8 channels, utilizing a 3×3 kernel, a stride of 2, and a padding of 1. Conv1 is followed by a second standard two-dimensional convolutional layer (Conv2) that expands the 8 channels to 16 channels, also utilizing a 3×3 kernel, a stride of 2, and a padding of 1. The use of a stride of 2 in these initial layers performs early spatial downsampling, rapidly reducing the computational burden for subsequent layers.

Following the standard convolutional layers, the CNN architecture includes a plurality of depthwise separable convolutional blocks. For example, the architecture may include three consecutive depthwise separable blocks. A first depthwise separable block (DS Block 2) applies a depthwise convolution (groups=16) to the 16-channel output of Conv 2, maintaining 16 channels, followed by a 1×1 pointwise convolution that expands the output to 32 channels. A second depthwise separable block (DS Block 3) applies a depthwise convolution to the 32 channels, followed by a 1×1 pointwise convolution expanding to 64 channels. A third depthwise separable block (DS Block 4) applies a depthwise convolution to the 64 channels, followed by a 1×1 pointwise convolution expanding to 128 channels. Each depthwise convolution in these blocks may utilize a 3×3 kernel, a stride of 2, and a padding of 1.

To map the extracted spatial and cross-channel features to the final classification classes, the output of the final depthwise separable block (e.g., the 128-channel output) is passed through a global average pooling layer (e.g., an AdaptiveAvgPool2D layer) to generate a 1×1 spatial output per channel. This pooled output is flattened (e.g., resulting in a 1D tensor of length 128) and passed through a first fully connected linear layer (FC1) that reduces the dimensionality from 128 to 64. The 64-dimensional output is then passed through a second fully connected linear layer (FC2) that outputs the final classification logits or probabilities. In some implementations, activation functions (e.g., ReLU) and normalization layers (e.g., Batch Normalization) may be interspersed between the convolutional and fully connected layers.

The output of the final fully connected layer (e.g., FC2) provides a classification for each of the N monitored seats. For example, if the system distinguishes between ‘adult’, ‘baby/child’, and ‘empty/non-living’, there would be 3 possible classes per seat. In this example, for N=5 seats, this results in 15 output nodes or probabilities, representing the classification for each seat across the three categories. The system interprets this output to assign a final label (e.g., adult, baby, empty/non-living) to each seat.

To further meet the constraints, the CNN model may undergo optimization, such as quantization. Quantization reduces the precision of the model's parameters (weights) and potentially activations from standard floating-point (e.g., 32-bit float) to lower-bit representations (e.g., 16-bit floating-point or 16-bit/8-bit fixed-point integers). This reduces the memory required to store the model (i.e., memory footprint) and can also speed up computation on hardware that supports lower-precision arithmetic efficiently. Techniques like Quantization Aware Training (QAT) can be employed, where the effects of quantization are simulated during the training process, often leading to better accuracy for the quantized model compared to post-training quantization.

Through the combination of efficient architecture design (e.g., depthwise separable convolutions, optimized filter sizes, etc.) and quantization (e.g., 16-bit), the resulting CNN model can achieve a small memory footprint (e.g., approximately 45 KB to 50 KB) and low computational complexity (e.g., around 800,000 to 1 million MAC operations per inference). This enables the model to run with very low latency (e.g., approximately 2.5 ms per inference) on the target ECU hardware, facilitating real-time cabin monitoring.

The CNN model is trained using a dataset comprising labeled radar data (e.g., the N×R×D tensors) collected under various representative in-cabin scenarios. These scenarios should cover different occupancy configurations, such as: single occupant (i.e., an adult) in various seats, single occupant (i.e., a baby/child) in a car seat, multiple adult occupants (e.g., 2, 3, 4, 5 adults), mixed occupants (e.g., adult(s) and baby/child), and empty cabin or cabin with non-living objects (e.g., bags, boxes) in seats.

Standard supervised learning techniques may be used for training, employing a suitable loss function (e.g., cross-entropy loss for multi-class classification, potentially applied per seat or globally) and an optimizer (e.g., Adam). The dataset may be split into training, validation, and testing subsets. Particularly when dealing with limited datasets for specific scenarios (e.g., diverse child presence examples), techniques such as data augmentation (applying transformations to existing data to increase variety) and/or transfer learning (leveraging parameters or features learned from models pre-trained on larger, potentially related datasets) may be employed during the training process to improve model robustness and generalization.

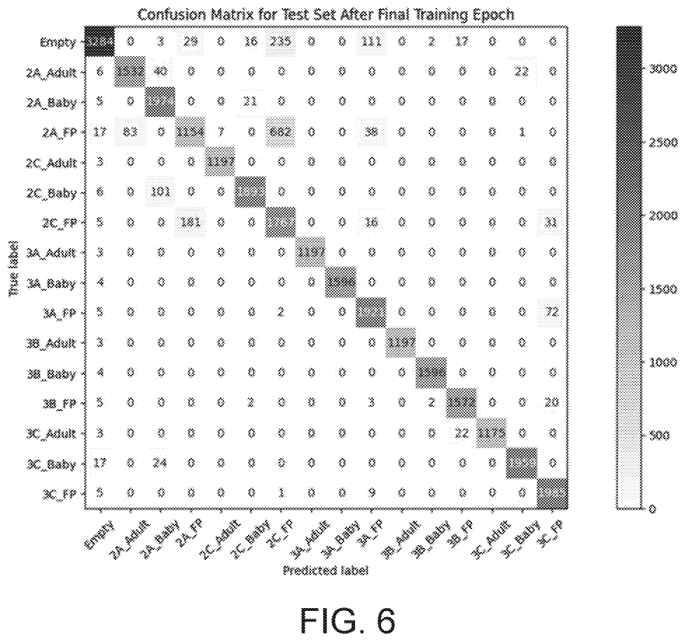

System performance may be evaluated using appropriate metrics, especially considering the potential multi-label nature (classifying multiple seats simultaneously). For each class (adult, baby, empty/non-living), metrics such as precision, recall, and F1-score are calculated. As shown in FIG. 6, Confusion matrices can be generated for each scenario or overall to understand misclassification patterns. Support (i.e., the number of samples per class) may be considered to assess dataset balance. Obtaining extensive, diverse real-world data for all occupant types and positions, particularly involving babies or children, can be challenging. This may result in some level of class imbalance in the training dataset, which may influence the performance metrics observed for the less represented classes and highlights an area for ongoing data collection.

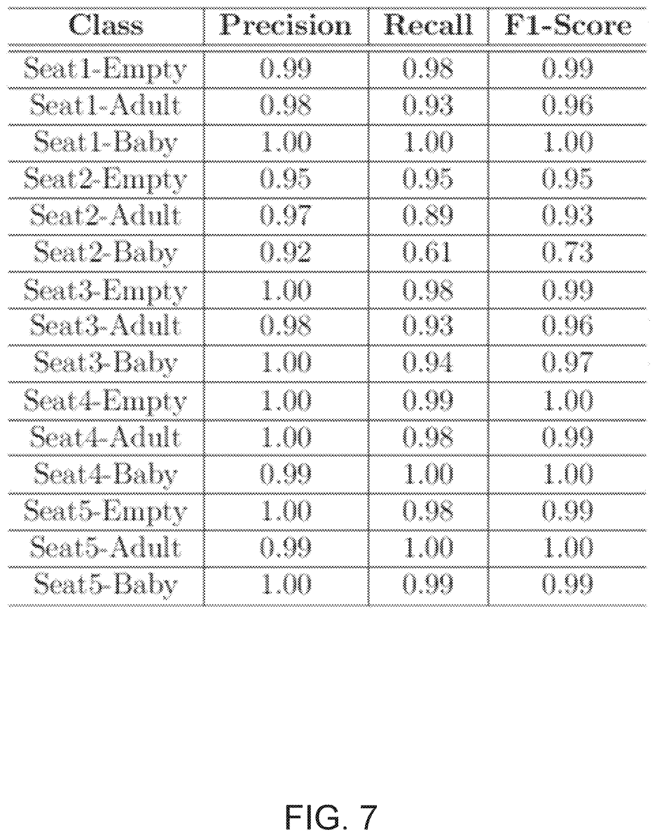

As shown in FIG. 7, experimental results based on simulations or testing with prototype hardware using the described methodology have shown high classification accuracy, potentially achieving average accuracies around 95-96%. The system demonstrates robust performance in distinguishing adults, babies/children, and non-living targets across single and multi-occupant scenarios. The overall accuracy and real-time capability (i.e., low latency, low memory/compute) validate the approach for automotive safety applications. The system effectively identifies non-living targets, minimizing false positives for occupant presence.

The system can be implemented using standard programming languages and frameworks. For model development, simulation, and training, Python with libraries like PyTorch or TensorFlow may be used. For deployment on an embedded ECU, the model may be converted to a format suitable for efficient inference libraries (e.g., TensorFlow Lite, ONNX Runtime, or vendor-specific inference engines) and implemented in languages like C or C++. The overall system can be designed modularly, with distinct software components for radar data acquisition, beamforming, pre-processing, CNN inference, and post-processing/output interpretation.

The vehicular cabin monitoring system offers several advantages. For example, the system provides enhanced safety by enabling applications like reliable child presence detection (CPD) and adaptive safety systems (e.g., airbags, seatbelts, etc.) based on accurate occupant classification. As another example, the system offers privacy preservation by using radar, which does not capture identifying visual images. As another example, the system is robust, as radar performance is less affected by lighting conditions (e.g., darkness, sunlight, etc.) compared to cameras. Moreover, the system provides real-time performance via an optimized model that achieves low latency suitable for immediate safety responses. The system is also suitable for embedded applications, as a low memory footprint and computational requirements allow deployment on cost-effective automotive hardware. Additionally, the system provides improved accuracy, as the combination of beam-steered data structuring and CNN processing overcomes limitations of traditional signal processing and addresses challenges like multipath reflections.

In summary, the system, utilizing FMCW radar with beam-steering to generate a structured multi-dimensional data representation (e.g., N×R×D tensor from per-seat RD maps) and processing this data with a highly optimized CNN employing depthwise separable convolutions and quantization, provides a robust, efficient, and privacy-preserving solution for real-time in-cabin occupant detection and classification, suitable for enhancing safety in modern vehicles. The processing of sensor data portions corresponding to different viewing angles (seats) to generate the 3D data structure allows the CNN to effectively classify occupants based on comprehensive spatial, range, and Doppler information.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311, US-2010-0245066, US-2024-0246536, and/or US-2025-0035766. which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:
a radar sensor disposed within an interior cabin of a vehicle, wherein the radar sensor captures radar sensor data within the interior cabin; and
an electronic control unit (ECU) comprising a processor and memory, wherein the ECU receives the captured radar sensor data and is configured to:
spatially resolve the radar sensor data to isolate signals corresponding to a plurality of occupant positions within the interior cabin;
generate a respective two-dimensional radar feature map for each occupant position of the plurality of occupant positions based on the spatially resolved radar sensor data;
generate a multi-dimensional data tensor combining the respective two-dimensional radar feature maps, wherein the multi-dimensional data tensor comprises a spatial dimension corresponding to the plurality of occupant positions;
provide the multi-dimensional data tensor as an input to a neural network executed by the processor, wherein the spatial dimension corresponding to the plurality of occupant positions is processed as an input channel dimension of the neural network; and
determine, based on an output of the neural network, a classification associated with occupancy for each occupant position of the plurality of occupant positions.

2. The vehicular cabin monitoring system of claim 1, wherein the radar sensor comprises a Frequency-Modulated Continuous-Wave (FMCW) radar sensor.

3. The vehicular cabin monitoring system of claim 1, wherein to spatially resolve the radar sensor data, the ECU is configured to apply receive beamforming to steer receive radar beams toward the plurality of occupant positions.

4. The vehicular cabin monitoring system of claim 1, wherein the respective two-dimensional radar feature map for each occupant position of the plurality of occupant positions comprises a Range-Doppler (RD) map.

5. The vehicular cabin monitoring system of claim 1, wherein the neural network comprises a convolutional neural network (CNN).

6. The vehicular cabin monitoring system of claim 5, wherein the CNN comprises at least one depthwise separable convolutional block configured to perform a depthwise convolution independently for each channel of the input channel dimension prior to performing a pointwise convolution.

7. The vehicular cabin monitoring system of claim 5, wherein parameters of the CNN are quantized to a 16-bit or 8-bit representation to reduce a memory footprint of the CNN.

8. The vehicular cabin monitoring system of claim 1, wherein the classification associated with occupancy for each occupant position comprises one of:
an adult occupant;
a child occupant; or
an empty seat or non-living object.

9. The vehicular cabin monitoring system of claim 1, wherein prior to generating the multi-dimensional data tensor, the ECU is configured to perform pre-processing on the radar sensor data, the pre-processing comprising at least one of:
noise reduction;
signal normalization; or
background clutter removal.

10. The vehicular cabin monitoring system of claim 1, wherein the ECU is further configured to, responsive to the determined classification for at least one occupant position of the plurality of occupant positions, generate an output signal to control a vehicle safety system or to generate an alert.

11. A method for monitoring a vehicular cabin, the method comprising:
capturing, by a radar sensor disposed within an interior cabin of a vehicle, radar sensor data within the interior cabin;
receiving, at an electronic control unit (ECU) comprising a processor and memory, the captured radar sensor data;
spatially resolving, by the ECU, the radar sensor data to isolate signals corresponding to a plurality of occupant positions within the interior cabin;
generating, by the ECU, a respective two-dimensional radar feature map for each occupant position of the plurality of occupant positions based on the spatially resolved radar sensor data;
generating, by the ECU, a multi-dimensional data tensor combining the respective two-dimensional radar feature maps, wherein the multi-dimensional data tensor comprises a spatial dimension corresponding to the plurality of occupant positions;
providing, by the ECU, the multi-dimensional data tensor as an input to a neural network executed by the processor, wherein the spatial dimension corresponding to the plurality of occupant positions is processed as an input channel dimension of the neural network; and
determining, by the ECU based on an output of the neural network, a classification associated with occupancy for each occupant position of the plurality of occupant positions.

12. The method of claim 11, wherein capturing the radar sensor data comprises capturing the radar sensor data using a Frequency-Modulated Continuous-Wave (FMCW) radar sensor.

13. The method of claim 11, wherein spatially resolving the radar sensor data comprises applying receive beamforming to steer receive radar beams toward the plurality of occupant positions.

14. The method of claim 11, wherein generating the respective two-dimensional radar feature map for each occupant position comprises generating a Range-Doppler (RD) map.

15. The method of claim 11, wherein the neural network comprises a convolutional neural network (CNN).

16. The method of claim 15, wherein processing the multi-dimensional data tensor by the CNN comprises performing, via at least one depthwise separable convolutional block of the CNN, a depthwise convolution independently for each channel of the input channel dimension prior to performing a pointwise convolution.

17. The method of claim 15, wherein parameters of the CNN are quantized to a 16-bit or 8-bit representation to reduce a memory footprint of the CNN.

18. The method of claim 11, wherein determining the classification for each occupant position comprises determining a classification of:
an adult occupant;
a child occupant; or
an empty seat or non-living object.

19. The method of claim 11, further comprising:
performing, by the ECU prior to generating the multi-dimensional data tensor, pre-processing on the radar sensor data, the pre-processing comprising at least one of:
noise reduction;
signal normalization; or
background clutter removal.

20. The method of claim 11, further comprising generating, by the ECU responsive to the determined classification for at least one occupant position of the plurality of occupant positions, an output signal to control a vehicle safety system or to generate an alert.
